(19) United States
(12) Patent Application Publication
(10) Pub. No.: US 2007/0252101 A1
(43) Pub. Date: Nov. 1, 2007

(54) Safety plug

(75) Inventor: Michael Khaitov, Carteret, NJ (US)

Correspondence Address: BERT P. KRAGES II;ATTORNEY AT LAW, 6665 SW HAMPTON ST, PORTLAND, OR, 97223, US

(73) Assignee: Coilhose Pneumatics, Inc.

(21) Appl. No.: 11/413,714

(22) Filed: Apr. 28, 2006

(51) Int. Cl. F16L 37/28

(52) U.S. Cl. 251/149.1

(57) ABSTRACT

A safety plug for use with a quick-disconnect coupler that incorporates a piston-type check valve. The check valve substantially reduces the reaction force caused by the residual compressed air when a hose is disconnected from a compressed air supply, and thus eliminates the danger of having the end of the hose whip about. The safety plug is readily assembled and disassembled for inspection and maintenance.

### CROSS-REFERENCE TO RELATED APPLICATIONS

None

### FEDERALLY SPONSORED RESEARCH

No

### SEQUENCE LISTING OF PROGRAM

Not Applicable

### BACKGROUND OF THE INVENTION

The present invention relates to a safety plug intended to be used with fluid handling systems using quick-release couplings. An example of such a system is a compressed air system comprising an air compressor, compressed air hose, and a tool powered by the flow of compressed air. However, the usefulness of the present invention is not limited to compressed air systems and will find application to systems involving other kinds of fluids.

Quick-release couplings are fittings that are commonly used to expedite the attachment of air tools and spray guns to air hoses, and also to attach air hoses to air compressors, by allowing a user to connect and disconnect compressed air hoses from tools or compressors in a much faster manner than the conventional alternative of connecting the threaded end of an air hose with a threaded fitting on the tool or compressor. Quick-release couplings consist of a plug member that is inserted into a receiving member known as a coupler by applying a short pushing motion. When the plug member is fully inserted into the coupler, it is secured by balls or pins in the coupler that engage a circumferential groove in the plug end of the connector. The balls or pins are held in place by a spring-loaded sleeve on the coupler. Concurrent with the insertion, the end of the plug engages and opens a spring-loaded valve in the coupler which allows fluid to flow between the passages at opposite ends of the plug and socket. The plug can be disconnected from the coupler by retracting the sleeve on the coupler, which releases the balls or pins and thereby permits the plug to be withdrawn from the coupler. The spring-loaded valve in the coupler then seats against a gasket and prevents fluid from exiting the coupler.

The most common application of quick release couplings is the attachment of the ends of air hoses to air tools. The industry convention in this context is for the coupler to be attached to the air hose and the plug to be attached to the tool or sprayer. However, it is also common to use quick-release couplings to attach air hoses to air compressors or compressed-air supply headers. In such cases, the plug element is normally installed at the end of the air hose and the coupler is attached to the air compressor or supply header. Such arrangements are particularly useful in situations where a user may find it desirable to switch to a hose having a different length or made from a material that is better suited for a specific environmental condition. However, disconnecting a pressurized hose from a compressed air supply can be very dangerous because the end of the hose may whip about in a dangerous manner due to the reaction force caused by the rapid release of the residual compressed air within the hose.

One approach for preventing the problem of hose whip associated with disconnecting air hoses is to use quick-release couplings that permit the plug and coupler to be disengaged in two steps. In the first step, the plug is moved a distance sufficient to allow the compressed air in the hose to vent while the plug remains connected to the coupler. In the second stage, the plug is completely released from the coupler. This approach requires couplings that are larger and heavier than standard couplings and is somewhat cumbersome to use because it requires two separate steps to disconnect a hose. An alternative approach is to use a safety plug that incorporates a check valve that impedes the exhaust of residual air from the air hose when the plug is disconnected from the coupler. Such plugs are known in the prior art and comprise check valves in the form of ball check, stem-mounted, and double shut-off valves. These kinds of valves overcome the limitations of two-step valves because they allow the user to disconnect the coupling in a single step.

Ball-check valves are well known in the prior art as a means of preventing back flow in fluid flow lines. Their popularity stems from the relative simplicity of design and their relative ease of manufacture. In the typical embodiments, such valves comprise a valve chamber in which a ball is free to travel longitudinally between the inlet and outlet portions of the valve chamber. The ball is restrained by a pin located towards the outlet end of the plug which prevents the ball from seating against the outlet end. Thus, when fluid is flowing through the plug, the ball lodges against the pin and the fluid passes through the generally annular space between the ball and the wall of the valve chamber. When the plug is disconnected from a coupler, back pressure from residual pressure in the hose forces the ball towards the inlet end of the plug where it lodges onto a valve seat and prevents the further release of fluid from the hose. A problem with the use of ball check valves is that they have a tendency to rattle within the housing which increases the turbulence of the fluid flowing through the valve and diminishes the quantity of flow through the plug. In addition, the check action of a ball check does not allow for the residual pressure to bleed from the safety plug which can make subsequent handling of the hose more difficult and also make it more hazardous to remove the safety plug from the hose. Ball-check safety plugs are also somewhat difficult to service because they require the use of tools to disassemble and reassemble. In addition, safety plugs with ball-check valves comprise small parts which are easy to drop and lose during the course of servicing.

Stem-mounted valves used in the context of couplings typically consist of an occluding member such as a disc or bulbous body mounted on a coaxial stem which is moveable over a distance sufficient to allow the occluding member to engage onto or disengage from a valve seat depending on the direction of the fluid flow. When in the open position, the fluid flows through an annular space between the occluding member and the wall of the valve body chamber. Often, the stem incorporates a spring mechanism to bias the occluding member into an open position. A problem with stem-mounted valves is that they can be somewhat fragile and difficult to assemble or service by users in the field because of small parts and special tool requirements.

The double shut-off type valve requires a coupling comprising two halves, each of which contains a spring-biased ball or poppet that prevents flow out of the hose or device to which a half is connected. When the halves of the coupler are put together, the balls or poppets push each another out of the way so as to open a flow passage through the coupling. When the halves are separated, the balls or poppets return to their seated positions and close the flow passages. If balls are used in these couplings, the flow area is relatively small which restricts the capacity of the coupling to accommodate efficient flow. Thus, to achieve acceptable flow rates, ball type couplers have to be made relatively large. They are also susceptible to being bumped and damaged. Double shut-off couplings with poppets usually consist of many parts, including complex arrangements for retaining a spring in each half to bias the ball or poppet in the shut position. Such couplings often require special tools to service and are not suitable for maintenance by ordinary users.

### SUMMARY OF THE INVENTION

The safety plug of the present invention incorporates a check valve comprising a slidable hollow piston with a conical or frusto-conical tip and lateral vents which permit the free flow of fluid into a fluid line such as an air hose when the plug is inserted into a standard or universal-type quick-release coupler. When the plug is disconnected from the coupler, the residual pressure in the hose forces the piston back towards the inlet end of the plug where the tip of the piston lodges against a valve seat, thus restricting the back flow of fluid which is the major cause of hose whip. The tip of the piston can also be provided with a narrow-diameter port that permits the residual fluid within the air hose to slowly bleed off into the atmosphere at a rate sufficiently low to preclude hose whipping. An example of an advantage of such a safety plug is that a user can connect and disconnect air hoses from the air system without having to rely on other safety features for protection against dangerous hose whip. Thus persons who works at locations with multiple employers, such as might be expected at a construction site, can protect themselves from hose whip by using hoses equipped with safety plugs. A distinct advantage of the present invention is that the piston arrangement permits construction of the plug in a substantially three-piece embodiment which can be readily dissembled and cleaned by users without the use of tools. For example, the plug can be made so that the valve chamber is formed from two threaded portions that can be assembled and disassembled by hand-turning the portions. The piston is relatively large in comparison to the ball bearings or stem fittings used in other kinds of check valves and is easier to handle and less prone to tumbling or springing out of the valve chamber and becoming lost. Furthermore, the piston is easier to handle and manipulate than a ball bearing or stem fitting.

The present invention also offers advantages with respect to manufacturing. The piston design, with its lateral ports, can be manufactured more efficiently than pistons with longitudinal air ports because a pair of lateral ports can be fabricated in a single drilling operation. Conversely, a piston that features two or longitudinal ports entails two or more drilling operations to fabricate those ports. Thus, the present invention offers the additional advantage of more efficient manufacture at a lower cost than some prior art designs.

### DESCRIPTION OF THE DRAWINGS

FIG. 1 is a cross-sectional view showing the present invention in a closed position.

FIG. 2 is a side view showing the exterior of the present invention in an assembled state.

FIG. 3 is a side view showing the present invention with its major components disassembled.

### DETAILED DESCRIPTION OF THE PREFERRED EMBODIMENT

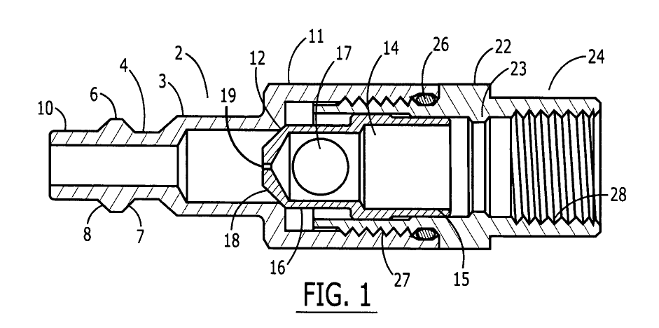

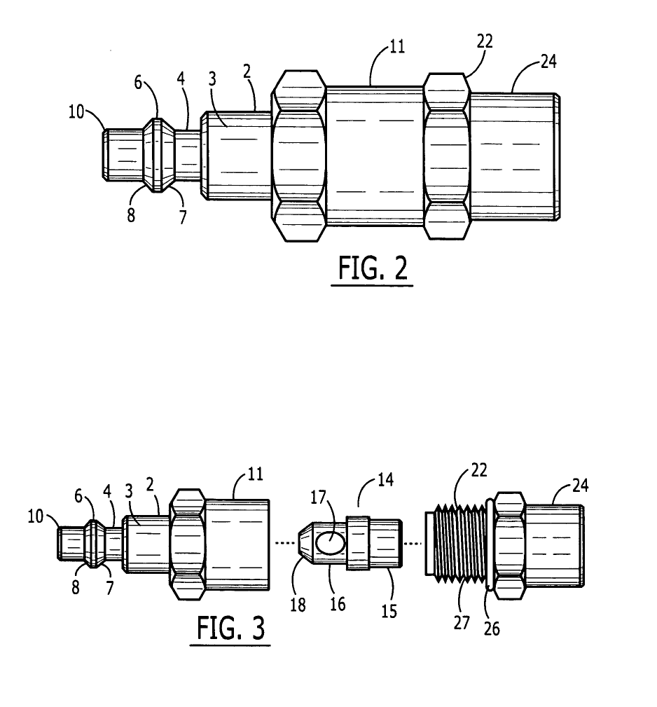

Referring now to the drawings FIGS. 1, 2, and 3, the connecting portion 2 consists of a generally cylindrical plug end 3 that includes a circumferential groove 4, a shoulder 6 having a sloped portion 7 on the groove side and a second sloped portion 8 connecting with a cylindrical sleeve 10 which forms the inlet end of the connector portion 2. The other end of the connector portion 2 consists of a generally cylindrical casing 11 which forms part of a valve housing in which the piston element 14 is nested.

The piston element 14 fits slidably into the cylindrical space encompassed by the base portion 22 which forms the other part of said valve housing. The base portion 22 has a threaded portion 27 which is engaged with the threads on the inside portion of casing 11 to form the valve housing. The base portion 22 also has a restraining ridge 23 at the end of the valve housing adjacent to a tubular outlet member 24. The outlet member 24 has interior threads 28 that are used to attach the safety plug to an air hose (not shown). When the threaded portion 27 of the base portion 22 is fully engaged with the threaded portion of the casing 11, the piston element 14 is slidably enclosed within said housing. An 0-ring 26 is affixed at the base of the threaded portion 27 of base portion 22 which ensures an airtight fit between the casing 11 and the base portion 22 are fully engaged and helps to secure the assembly of the pieces by providing a slight but significant resistance to unthreading.

In the preferred embodiment, the piston element 14 is fabricated from a single piece of brass and comprises a hollow cylindrical base section 15 which has a diameter slightly less than the diameter of the cylindrical space encompassed by base portion 22. Adjacent to the base section 15 is a hollow cylindrical intermediate section 16 which has a diameter less than that of base portion 15. The purpose of having an intermediate section 16 is to increase the volume and cross-sectional area of the substantially-annular space formed between intermediate section 16 and the interior wall of the valve housing formed by casing 11 and base portion 22, and thus facilitate the flow of fluid within this space. Intermediate section 16 also comprises lateral openings 17 which allow fluid to flow from said substantially-annular space into the interior space encompassed by piston element 14. The piston element 14 also comprises a frusto-conical tip 18 at the end opposite from the base section 15. A small port 19 is located at the end of the frusto-conical tip which allows pressurized fluid to vent slowly from an attached hose after the safety plug has been disconnected from a coupler.

The safety plug is intended to be used in conjunction with a coupler. In the most common scenario, the outlet member 24 of the plug will be attached to an air hose by connecting it to a threaded element at the end of the air hose. The coupler would ordinarily be expected to be attached to an air compressor or air-supply header but conceivably could be attached to another air hose. The user connects the safety plug to a coupler by positioning the cylindrical sleeve 10 of the safety plug within the opening of a coupler and pushing the plug into the coupler until the shoulder 6 passes the locking balls or pins of the coupler and causes them to engage the circumferential groove 4 of the plug. At this point, a retaining sleeve on the coupler will secure the locking balls or pins within the space of the circumferential groove 4 and hold the plug onto the coupler. Concurrently, the cylindrical sleeve 10 will engage and open a self-sealing valve in the coupler and thus cause the plug and coupler to be in fluid communication. Once the safety plug is secured onto the coupler, the force of compressed air flowing from the coupler into the plug will force the piston 14 to move away from the valve seat 12 and to lodge against the restraining ridge 23. When the piston 14 is lodged against the restraining ridge, compressed air can freely flow through the passage within the connecting portion 2, pass through the lateral openings 17 in the piston 14, and exit from the outlet member 24.

The safety plug can be disconnected from a coupler by the user: (1) holding the coupler in one hand and the end of the hose with the safety plug in the other; (2) retracting the retaining sleeve of the coupler which allows the locking balls or pins to disengage their secure contact with the circumferential groove 4; and (3) withdrawing the safety plug from the coupler by pulling the end of the air hose away from the coupler. At the instant that the safety plug ceases to be pressurized by the air contained in the coupler, the residual pressure in the air hose attached to the safety plug will cause air to flow towards the plug end 3. This flow will force the piston 14 to move away from the restraining ridge 23 and to lodge against the valve seat 12 and thus block the flow of air towards the plug end 3. In the preferred embodiment, the small port 19 in the frusto-conical tip 18 of the piston 14 allows air to slowly bleed from the piston and thus allows the air hose to depressurize at a rate that does not create sufficient reaction force to cause the hose to whip about.

The present invention is not limited to the embodiment described above but may be modified in various ways without departing the spirit and scope of the invention. For example, the construction of the piston element 14 can be varied in terms of the shape of the tip, thicknesses, and materials. Likewise, others means of fitting the base portion 2 and connecting portion 22 together can be used such as bayonet-style connections and clips. The connector portion 2 can be adapted to accommodate any of the standard interchanges used in the art and can also be attached to the casing 11 by means to effect a ball-swivel connector. The invention is suitable for use with systems that utilize fluids other than compressed air such as hydraulic fluids, fuels, and other kinds of compressed gases.

What is claimed is:

1. A safety plug for use with a coupler attached to a fluid-conducting line, whereby said safety plug comprises:
a valve housing having an interior chamber with a cross-sectional area in which a piston is axially located for a reciprocating movement within said interior chamber;
further comprising an inlet end having a male plug that can be engaged with said coupler, and an inlet port for introducing fluid into said interior chamber of said valve housing;
further comprising an outlet end having a means for attaching said safety plug to the end of a hose, pipe, or like fluid-conducting line, and an outlet port for discharging fluid from said interior chamber into said hose, pipe, or fluid-conducting line;
wherein said piston comprises an axial portion with a cross-sectional area smaller than the cross-sectional area of said interior chamber and a hollow interior, said piston having a tip at a first end and an opening at a second end, said tip providing a seating area that substantially blocks the backflow of said fluid into said inlet port when the safety plug is in a disconnected state with respect to a coupler and said fluid is present in said interior chamber in a pressurized state; and
wherein said piston further comprises lateral openings on said axial portion which allow fluid entering said inlet port to flow through said lateral openings into said hollow interior of said piston and flow out said opening of said piston, and into said outlet port when the safety plug is in a connected state with a coupler.

2. The safety plug of claim 1 in which said tip of said piston comprises a small port that allows fluid under residual pressure within said interior chamber to bleed from said tip.

3. The safety plug of claim 1 in which said tip of said piston has a conical shape.

4. The safety plug of claim 1 in which said tip of said piston has a conical shape and comprises a small port that allows fluid under residual pressure within said interior chamber to bleed from said tip.

5. The safety plug of claim 1 in which said tip of said piston has a frusto-conical shape.

6. The safety plug of claim 1 in which said tip of said piston has a frusto-conical shape and comprises a small port that allows fluid under residual pressure within said interior chamber to bleed from said tip.

7. A safety plug for use with a coupler attached to a fluid-conducting line, whereby said safety plug:
comprises a valve housing formed by a first member and a second member which can be selectably joined together to define an interior chamber with a cross-sectional area in which a piston is axially located for reciprocating movement within said interior chamber;
said first member comprising a male plug that can be engaged with said coupler and further comprising an inlet port for introducing fluid into said interior chamber of said valve housing;
said second member comprising a means for attaching said safety plug to the end of a hose, pipe, or like fluid-conducting line, and further comprising an outlet port for discharging fluid from said interior chamber of said valve housing into said hose, pipe, or fluid-conducting line;
wherein said piston comprises an axial portion with a cross-sectional area smaller than the cross-sectional area of said interior chamber and a hollow interior, said piston having a tip at a first end and an opening at a second end, said tip providing a seating area that substantially blocks the backflow of said fluid into said inlet port of said first member when the safety plug is in a disconnected state with respect to a coupler and said fluid is present in said interior chamber in a pressurized state; and
wherein said piston further comprises lateral openings on said axial portion which allow fluid entering said inlet port of said first member to flow through said lateral openings into said hollow interior of said piston and out from said opening of said piston, and into the outlet port of said second member when the safety plug is in a connected state with a coupler.

8. The safety plug of claim 7 in which said tip of said piston comprises a small port that allows fluid under residual pressure within said interior chamber to bleed from said tip.

9. The safety plug of claim 7 in which said tip of said piston has a conical shape.

10. The safety plug of claim 7 in which said tip of said piston has a conical shape and comprises a small port that allows fluid under residual pressure within said interior chamber to bleed from said tip.

11. The safety plug of claim 7 in which said tip of said piston has a frusto-conical shape.

12. The safety plug of claim 7 in which said tip of said piston has a frusto-conical shape and comprises a small port that allows fluid under residual pressure within said interior chamber to bleed from said tip.

13. The safety plug of claim 7 in which the valve housing can be selectably joined and unjoined by means of threaded elements on said first member and said second member.

14. The safety plug of claim 7 in which the valve housing can be selectably joined and unjoined by means of threaded elements on said first member and in which the said tip of said piston comprises a small port that allows fluid under residual pressure within said interior chamber to bleed from said tip.

15. The safety plug of claim 7 in which the valve housing can be selectably joined and unjoined by means of threaded elements on said first member and said second member and in which said tip of said piston has a conical shape.

16. The safety plug of claim 7 in which the valve housing can be selectably joined and unjoined by means of threaded elements on said first member and said second member, and in which said tip of said piston has a conical shape and comprises a small port that allows fluid under residual pressure within said interior chamber to bleed from said tip.

17. The safety plug of claim 7 in which the valve housing can be selectably joined and unjoined by means of threaded elements on said first member and said second member and said second member and in which said tip of said piston has a frusto-conical shape.

18. The safety plug of claim 7 in which the valve housing can be selectably joined and unjoined by means of threaded elements on said first member and said second member and in which said tip of said piston has a frusto-conical shape and comprises a small port that allows fluid under residual pressure within said interior chamber to bleed from said tip.

19. A safety plug for use with a coupler attached to a fluid-conducting line, whereby said safety plug:
comprises a valve housing having a substantially cylindrical interior chamber with a cross-sectional area in which a substantially cylindrical piston is axially located for a reciprocating movement within said interior chamber;
further comprising an inlet end having a male plug that can be engaged with said coupler, and an inlet port for introducing fluid into said interior chamber of said valve housing;
further comprising an outlet end having a means for attaching said safety plug to the end of a hose, pipe, or like fluid-conducting line, and an outlet port for discharging fluid from said interior chamber into said hose, pipe, or fluid-conducting line;
wherein said piston comprises an axial portion with a cross-sectional diameter smaller than the cross-sectional diameter of said interior chamber and a hollow interior, said piston having a tip at a first end and an opening at a second end, said tip providing a seating area that substantially blocks the backflow of said fluid into said inlet port when the safety plug is in a disconnected state with respect to a coupler and said fluid is present in said interior chamber in a pressurized state; and
wherein said piston further comprises lateral openings on said axial portion which allow fluid entering said inlet port to flow through said lateral openings into said hollow interior of said piston and flow into said outlet port when the safety plug is in a connected state with a coupler.

20. The safety plug of claim 19 further comprising a first member and a second member which can be selectably joined together to define said interior chamber.
